(19) United States
(12) Patent Application Publication
(10) Pub. No.: US 2015/0152276 A1
(43) Pub. Date: Jun. 4, 2015

(54) CYCLICALLY OSCILLATING INK

(71) Applicant: SRI INTERNATIONAL, Menlo Park, CA (US)

(72) Inventors: CHARLES M. PATTON, Eugene, OR (US); Patrick D. Lincoln, Woodside, CA (US)

(73) Assignee: SRI INTERNATIONAL, Menlo Park, CA (US)

(21) Appl. No.: 14/094,242

(22) Filed: Dec. 2, 2013

(51) Int. Cl. C09D 11/52; C09D 11/16; B43K 29/12; C09D 11/14; B41F 31/00; B43K 5/02

(52) U.S. Cl. CPC C09D 11/52; B41F 31/00; B43K 5/025; B43K 29/12; C09D 11/14; C09D 11/16

(57) ABSTRACT

An ink includes a binder and a plurality of particulate oscillators suspended in the binder, wherein a visible phase of each of the plurality of particulate oscillators varies in a cyclic manner. In another embodiment, a printing implement includes an ink containing a plurality of particulate oscillators, wherein a visible phase of each of the plurality of particulate oscillators varies in a cyclic manner, and an outlet for dispensing the ink from the printing implement. In a further embodiment, a writing set includes an ink containing a plurality of particulate oscillators, wherein a visible phase of each of the plurality of particulate oscillators varies in a cyclic manner, and a writing surface containing a stimulus that resets the visible phase when the ink is applied to the writing surface.

### FIELD OF THE INVENTION

The present invention relates generally to inks, and relates more particularly to inks that are capable of visually reproducing the dynamics in which they are applied to a surface.

### BACKGROUND OF THE DISCLOSURE

Handwriting (e.g., drawing with pigment or dye on a substrate) has strongly shaped human consciousness, and is one of the primary ways in which humans communicate knowledge. While handwriting can beautifully capture shape, however, it does not capture the dynamics or reproduce the motions that created the shape. The ability to visually reproduce the dynamics of handwriting could be invaluable in many fields, including the teaching of handwriting. For instance, in certain languages, the order in which certain strokes are executed to produce a written character is critical.

Some of the earliest known human cave paintings show that early humans were aware of the time dimension in drawings and sought ways to illustrate this dimension in drawings; however, to date, a robust and economical mechanism for reproducing the time dimension of drawings has yet to be proposed. Conventional solutions include mostly computer-based approaches (e.g., video recordings) that are highly infrastructure-dependent, have a high cost of entry and upkeep, and very low robustness.

### SUMMARY OF THE INVENTION

In one embodiment, an ink includes a binder and a plurality of particulate oscillators suspended in the binder, wherein a visible phase of each of the plurality of particulate oscillators varies in a cyclic manner. For instance, the variation in the visible phase may manifest in the ink changing from a first color to a second color, then back to the first color.

In another embodiment, a printing implement includes an ink containing a plurality of particulate oscillators, wherein a visible phase of each of the plurality of particulate oscillators varies in a cyclic manner, and an outlet for dispensing the ink from the printing implement.

In a further embodiment, a writing set includes an ink containing a plurality of particulate oscillators, wherein a visible phase of each of the plurality of particulate oscillators varies in a cyclic manner, and a writing surface containing a stimulus that resets the visible phase when the ink is applied to the writing surface.

### BRIEF DESCRIPTION OF THE DRAWINGS

The teachings of the present invention can be readily understood by considering the following detailed description in conjunction with the accompanying drawings, in which:

FIG. 1 illustrates a cyclically oscillating ink, according to one embodiment of the present invention;

FIG. 2 illustrates a printing implement that is capable of dispensing a cyclically oscillating ink, according to another embodiment of the present invention;

FIG. 3 illustrates a printer that is capable of dispensing a cyclically oscillating ink, according to another embodiment of the present invention;

FIG. 4A is an exploded view of one embodiment of a display including a plurality of oscillating optical elements;

FIG. 4B is a cross sectional view of the display illustrated in FIG. 4A;

FIG. 5, for example, illustrates one embodiment of an optical element that is powered directly by light; and

FIG. 6 illustrates a substrate to which a plurality of light powered optical elements such as the optical element illustrated in FIG. 5 have been adhered.

To facilitate understanding, identical reference numerals have sometimes been used to designate elements common to multiple figures.

### DETAILED DESCRIPTION

The present invention relates to a cyclically oscillating ink. Embodiments of the invention provide an ink that is capable of visually “re-drawing”its path on a surface, such that the order of the strokes in which the ink was applied to the surface can be easily reviewed at a point in time after the application of the ink.

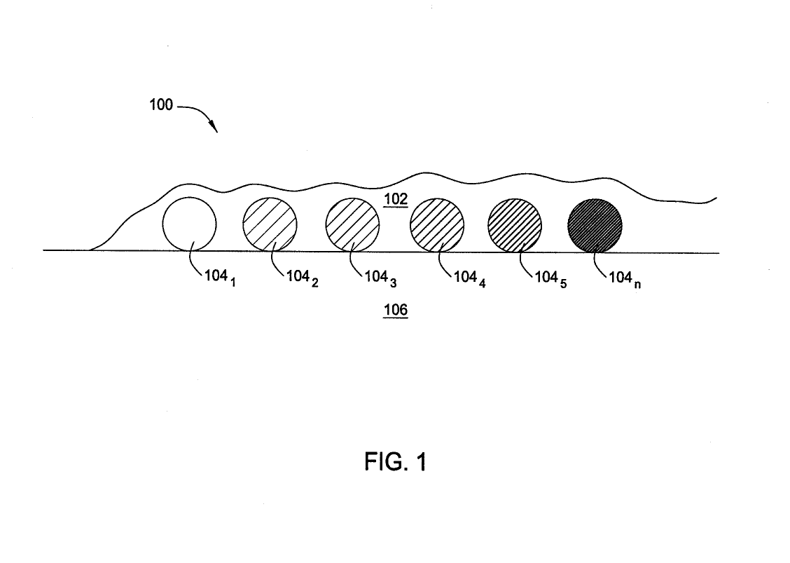

FIG. 1 illustrates a cyclically oscillating ink 100, according to one embodiment of the present invention. The ink 100 comprises an ink binder 102 in which a plurality of particulate oscillators 104₁-104ₙ (hereinafter collectively referred to as “oscillators 104” or “particulate oscillators 104”) is suspended.

In one embodiment, the ink binder 102 is transparent or substantially transparent (e.g., at least partially capable of allowing light to pass through, if not perfectly transparent). For instance, the binder 102 may comprise a solution of gum Arabic and water. When the binder 102 evaporates, the oscillators 104 are adhered to the surface 106 to which the ink 100 is applied.

The particulate oscillators 104 have visible phases that vary in a cyclic manner, as illustrated by the variation in the shading of the oscillators 104. The oscillators in this embodiment have a visual phase state that can be re-set (either manually or automatically through application of some stimulus) after application to the surface 106. In one embodiment, the visual state of each of the oscillators 104 varies at the same rate. For instance, the oscillators 104 may cycle through one or more shades from white to black to simultaneously, but in a way that signifies the order, up to the period of oscillation, in which the oscillators 104 were applied to the surface 106. In this way, the location of the writing implement that applied the ink 100 is captured and replayed, not only with respect to the location on the surface 106, but also dynamically, over time. The stimulus that drives the oscillation may be, for example, a magnetic stimulus, an electrical stimulus, or a chemical stimulus.

The mechanism by which oscillation of the oscillators 104 is driven may vary. For instance, the oscillation may be light-driven (e.g., activated upon exposure to light), chemically driven (e.g., activated upon exposure to a particular substance), or electrostatically driven (e.g., activated upon exposure to an electrostatic charge).

In a further embodiment, the oscillation corresponds to a change in the chemical state of the oscillators 104. For instance, the change in chemical state may comprise a change in the balance of activation states among a plurality of dyes in the ink 100 or a capture of light by a substance (e.g., titanium dioxide) in the ink 100.

In a further embodiment still, the oscillation corresponds to a change in the mechanical state of the oscillators 104. For instance, the change in mechanical state may comprise a change in the physical position of a conductor within the ink.

In a further embodiment still, the oscillation corresponds to a change in the electrical state of the oscillators 104.

In one embodiment, the surface 106 contains a stimulus that resets the visual phase of the oscillators 104 when the ink 100 is applied to the surface 106. For instance, the surface 106 may contain a first chemical that reacts with a second chemical in the ink 100 to reset the visual phase. Alternatively, the surface 106 may contain an embedded magnetic or electrical stimulus that causes the visual phase of the oscillators 104 to be reset.

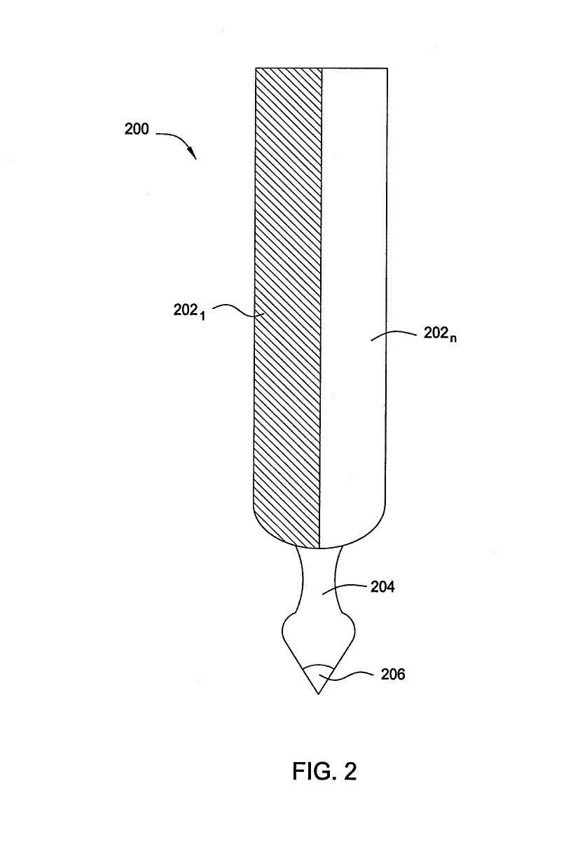

FIG. 2 illustrates a printing implement 200 that is capable of dispensing a cyclically oscillating ink, according to another embodiment of the present invention. As illustrated, the printing implement 200 generally comprises one or more reservoirs 202₁-202ₙ (hereinafter collectively referred to as “reservoirs 202”) for containing various components of the ink and an outlet 204 for dispensing the ink.

For instance, a first reservoir 202₁ may contain a first component of the ink, and a second reservoir 202ₙ may comprise a second component of the ink. The first and second components of the ink may contain substances that, when mixed, produce the oscillating behavior described above. For instance, the first component of the ink may contain bromine, while the second component of the ink may contain an acid. The reservoirs 202 maintain separation of these components until the components are simultaneously dispensed by the outlet 204 and caused to mix.

In one embodiment, the printing implement 200 further comprises a stimulus 206 positioned near the outlet, where the stimulus resets the visible phase of the oscillators in the ink upon dispensing of the ink from the outlet 204. The stimulus 206 may comprise, for instance, a magnetic stimulus, a chemical stimulus, or an electrical stimulus that brings a charge in close proximity to the mix of ink components, where the charge triggers the oscillations.

Although the printing implement 200 is illustrated as including a plurality of reservoirs that each contains a different component of the ink, in an alternative embodiment, the printing implement 200 may include only a single reservoir. In this case, the ink is “pre-mixed,” and may include a chemical oscillator comprising a plurality of nanoparticles.

Furthermore, although the printing implement 200 is illustrated in FIG. 2 as comprising a writing implement (e.g., a pen), it will be appreciated that the printing implement 200 could also be configured as an electronic printer. For example, an inkjet print head could serve as a bundle of printing implements such as the one illustrated in FIG. 2.

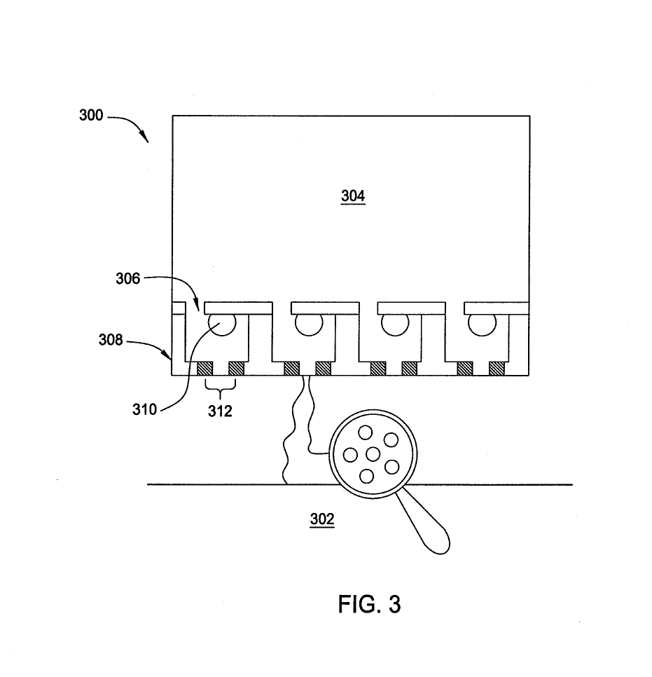

FIG. 3, for example, illustrates a printer 300 that is capable of dispensing a cyclically oscillating ink, according to another embodiment of the present invention. The printer 300 generally comprises a reservoir 304 for containing the ink and a plurality of print heads for dispensing the ink. In one embodiment, a given print head approximately matches the physical dimensions of the area 302 to be printed (e.g., a business card).

Each of the print heads generally comprises a refill channel 306 for replenishing its supply of ink from the reservoir 304, a respective opening in a nozzle plate 308 for dispensing the ink onto the area 302 to be printed, a resistive heater 310 for causing droplets of the ink to be ejected through the opening, and a magnet 312 positioned around the opening to reset the phase of the oscillators in the ink.

When considering conventional “static” ink, the time at which the ink is applied to the area 302 is immaterial, and hence, the printer is free to move a smaller print head around and over the area, applying the ink in an arbitrary time order. However, in the embodiment illustrated in FIG. 3, the time, as well as the position, of application is significant. In one embodiment, at the appropriate time, the resistive heater 310 of the selected print head is activated, causing an ink droplet to be ejected from the print head and onto the area 302 to be printed. As the ink exits the print head via the nozzle plate 308, the magnet 312 resets the phase of the oscillators in the ink so that they are encoded with a particular phase as they are applied to the area 302.

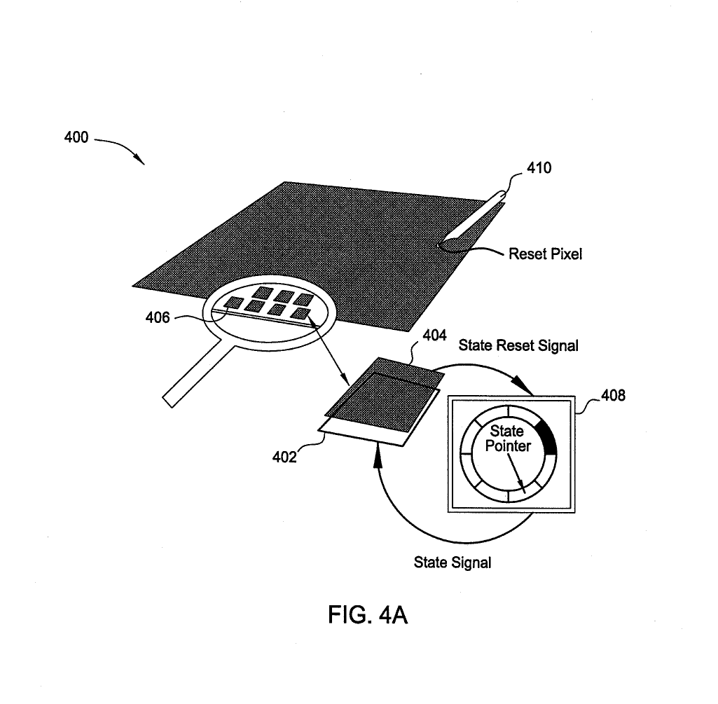

In further embodiments, the “ink” may be implemented digitally in a display and its oscillations may be activated by application of a stimulus that permeates through the display. For instance, FIGS. 4A-4B collectively illustrate one embodiment of a display 400 including a plurality of oscillating optical elements. Specifically, FIG. 4A is an exploded view of one embodiment of a display 400 including a plurality of oscillating optical elements, and FIG. 4B is a cross sectional view of the display 400 illustrated in FIG. 4A.

As illustrated, the display 400 includes a plurality of layers, including a first layer 402 for carrying the plurality of picture elements 406 and a second layer 404, positioned over or under the first layer 402, which functions as a touch-responsive screen. Additionally, the display 400 may include a third layer 412 and a fourth layer 414 (at least one of which is substantially transparent), between which the first layer 402 and the second layer 404 are effectively sandwiched, for providing electrical power and closing the electrical circuit. Thus, the display 400 is self-contained.

The plurality of picture elements 406 (e.g., pixels) collectively occupy a majority of the area of the first layer 402 (e.g., similar to the arrangement of a conventional liquid crystal display). Each picture element 406 includes an optical element that is capable of presenting at least two distinct visual states (in FIG. 4A, two visual states are illustrated: white and black). At any given time, the state of the optical element is determined by the history of an incoming state signal.

Each picture element 406 is also associated with a driver 408 that is functionally connected to both the optical element and to the second layer 404. The driver 408 comprises a predetermined loop of visual states for the optical element, a state pointer to the optical element's current state, and a time-based sequencer that loop-increments the state pointer at a fixed rate. The driver 408 may also accept a state reset signal that, when activated, changes the state pointer to a predetermined, fixed state. The driver 408 emits a state signal corresponding to a recorded visual state associated with the value of the state pointer.

When no picture element 406 has been activated (e.g., when a corresponding area of the second layer 404 has not been touched, for example by a user's finger or by a stylus 410), each picture element's driver 408 cycles through the visual states, all at the same rate, though the particular visual state may vary from picture element-to-picture element at any given time (that is, all of picture elements 406 will not necessarily display the same visual state at the same time). Once a picture element 406 is activated, a state reset signal is sent to the corresponding driver 408, and the picture element's visual state is held static in the fixed reset state until such time as it is deactivated (e.g., contact with the user's finger or the stylus 410 is broken). When the picture element 406 is deactivated, the driver 408 resumes cycling through the visual states starting from the reset state.

The net effect of drawing on the display 400 is that the time-sequence of picture element activations (e.g., touches to the display) is recorded in the phase differences of the visual states of the picture elements 406 and replayed in a continuous loop.

In an alternate embodiment, the drivers 408 are powered directly by light rather than powered indirectly through light-to-electrical power conversion. In one particular embodiment, the driver 408 employs a nano-scale photon mill that provides reciprocating power. One exemplary analog of Crooke's radiometer is the gold nanoparticle gammadion, which resembles a warped gold cross, is a few tens of nanometers in overall size, and acquires angular momentum around its axis of rotational symmetry when exposed to light.

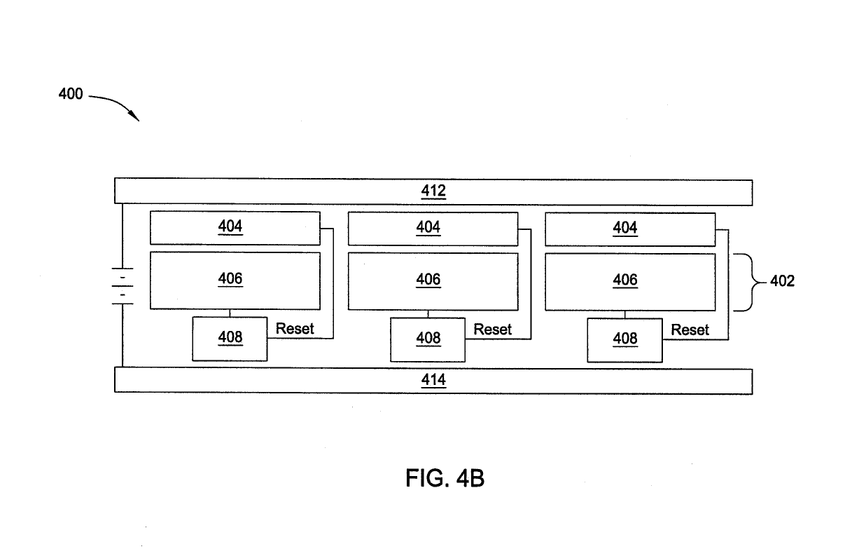

FIG. 5, for example, illustrates one embodiment of an optical element 500 that is powered directly by light. The optical element 500 includes a nano-scale photon mill 502 (in this exemplary embodiment, a gammadion) attached to a gyre pixel 504 (i.e., an asymmetrically colored sphere) that is tens or hundreds of nanometers in diameter. Both the photo mill 502 and the gyre pixel 504 are secured in a large sphere 506 (e.g., with a common axle 508).

The dynamic optical element 500 changes visual state (from an observer's perspective) when exposed to light. Specifically, upon exposure to light, the optical element 500 periodically presents one hemisphere (e.g., the dark-colored hemisphere) to a viewer, and subsequently presents the other hemisphere (e.g., the light-colored one).

In one embodiment, the gyre pixel 504 is asymmetrically ferromagnetic in addition to being asymmetrically colored. For instance, iron nano particles may be applied to one hemisphere. In this case, the optical element 500 could be rotated to a fixed position (thus affecting a state reset) simply by bringing it in contact with a magnetic stimulus (e.g., a stylus).

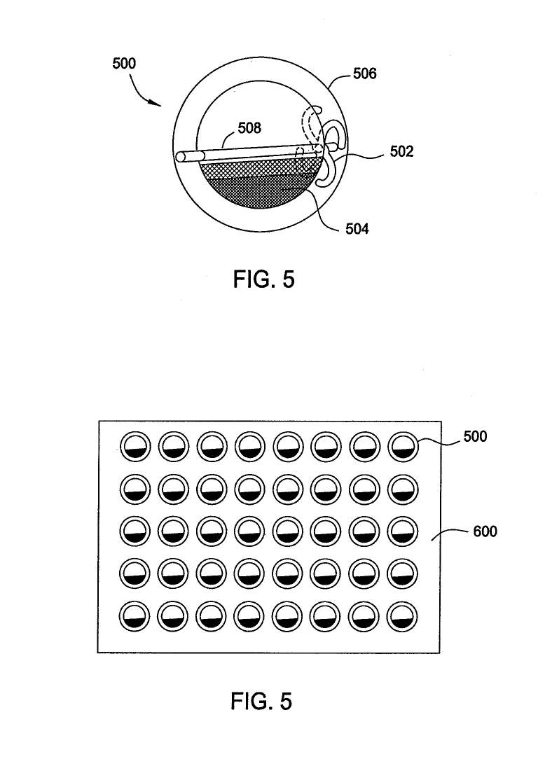

FIG. 6 illustrates a substrate 600 to which a plurality of light powered optical elements 500 such as the optical element 500 illustrated in FIG. 5 have been adhered. The substrate 600 may function as an alternative to the display 400 illustrated in FIGS. 4A-4B. In particular, the substrate 600 presents a display surface whose power source is local and self-contained, and whose size approaches that of pigment particles in ordinary ink.

In certain embodiments, the issue of creating an appropriate animation sequence, given the averaging properties of human vision, can be ameliorated through the observation that, given an appropriate index of refraction, the visual impact of an optical element state may be constrained to depend on a much smaller area of the gyre pixel than would apply otherwise.

For instance, an ordinary view of one of the optical elements 500 might average over colors from white to black. However, if the encapsulating sphere 506 is filled with a medium having a higher index of refraction than the gyre pixel 504, a viewer viewing the optical element straight-on would see a much enlarged (and much restricted) aspect of the gyre pixel 504. That is, the visual output of the optical element 500 would be focused on only a small area of the gyre pixel 504 at any moment.

In the simplest model, the state value, G(X) of an optical element, at orientation X is given by a (scaled) integral of the state values around that orientation (e.g., from X−A to X=4−A; in the case of a sphere, where offset A depends on the optics, and could equal ninety degrees). Given the state value G, a real or vector-valued function of the orientation, one must determine F, a de-averaged version of function, such that the averaged version (i.e., the integral of F from X−A to X+A) is, for each orientation, equal to G(X).

Simple differentiations yield an equation indicating that the difference between the values of F at “antipodal” (i.e., +A, −A) orientations should be equal to the derivative of the target, G, at the current orientation.

With respect to colored optical element content, both the value of G and the value of F must lie in the finite range from totally unsaturated to totally saturated (e.g., from one hundred percent white to one hundred percent black, or, more generally, from zero to one).

Thus, the desired animation function G(X) must have a bounded time derivative, since it must be capable of being represented at each instant as a fixed multiple of the difference between values of F. If it is further required that the derivative of G at any orientation be the negative of its derivative at the antipodal orientation, then a solution can be obtained by setting the value of F at each orientation to be the mid-scale value (e.g., 0.5) plus or minus the scaled value of the derivative of G at orientation X−A or X+A, respectively.

Although various embodiments which incorporate the teachings of the present invention have been shown and described in detail herein, those skilled in the art can readily devise many other varied embodiments that still incorporate these teachings.

What is claimed is:

1. An ink, comprising:
a binder; and
a plurality of particulate oscillators suspended in the binder, wherein a visible phase of each of the plurality of particulate oscillators varies in a cyclic manner.

2. The ink of claim 1, wherein the plurality of particulate oscillators is light-driven.

3. The ink of claim 1, wherein the plurality of particulate oscillators is chemically-driven.

4. The ink of claim 1, wherein the plurality of particulate oscillators is electrostatically-driven.

5. The ink of claim 1, wherein an oscillation in at least some of the plurality of particulate oscillators corresponds to a change in a chemical state of the at least some of the plurality of particulate oscillators.

6. The ink of claim 5, wherein the change in the chemical state comprises a change in a balance of activation states among a plurality of dyes.

7. The ink of claim 5, wherein the change in the chemical state comprises a capture of light by titanium dioxide.

8. The ink of claim 1, wherein an oscillation in at least some of the plurality of particulate oscillators corresponds to a change in a mechanical state of the at least some of the plurality of particulate oscillators.

9. The ink of claim 8, wherein the change in the mechanical state comprises a change in a physical position of a conductor within a medium.

10. The ink of claim 1, wherein an oscillation in at least some of the plurality of particulate oscillators corresponds to a change in an electrical state of the at least some of the plurality of particulate oscillators.

11. The ink of claim 1, wherein the binder evaporates upon an application of the ink to a surface.

12. The ink of claim 1, wherein the binder comprises gum arabic.

13. The ink of claim 1, wherein the visible phase resets in response to an application of a stimulus.

14. The ink of claim 5, wherein the stimulus is magnetic.

15. The ink of claim 5, wherein the stimulus is electrical.

16. The ink of claim 5, wherein the stimulus is chemical.

17. The ink of claim 1, wherein the visible phase of each of the plurality of particulate oscillators varies at a same rate.

18. A printing implement, comprising:
an ink containing a plurality of particulate oscillators, wherein a visible phase of each of the plurality of particulate oscillators varies in a cyclic manner; and
an outlet for dispensing the ink from the printing implement.

19. The printing implement of claim 18, further comprising:
a first reservoir containing a first component of the ink; and
a second reservoir containing a second component of the ink,
wherein the outlet is coupled to the first reservoir and to the second reservoir in a manner that causes the first component and the second component to mix when the ink is dispensed.

20. The printing implement of claim 19, wherein the first component contains bromine, and the second component contains an acid.

21. The printing implement of claim 18, further comprising:
a stimulus positioned near the outlet that resets the visible phase upon the dispensing.

22. The printing implement of claim 21, wherein the stimulus is a magnetic stimulus.

23. The printing implement of claim 21, wherein the stimulus is an electrical stimulus.

24. The printing implement of claim 21, wherein the stimulus is a chemical stimulus.

25. The printing implement of claim 18, wherein the chemical oscillator comprises a plurality of nanoparticles.

26. The printing implement of claim 18, wherein the printing implement is a manually operable pen.

27. The printing implement of claim 18, wherein the printing implement is a printer.

28. A writing set, comprising:
an ink containing a plurality of particulate oscillators, wherein a visible phase of each of the plurality of particulate oscillators varies in a cyclic manner; and
a writing surface containing a stimulus that resets the visible phase when the ink is applied to the writing surface.

29. The writing set of claim 28, wherein the stimulus is a first chemical that reacts with a second chemical contained in the ink.

30. The writing set of claim 28, wherein the stimulus is a magnetic stimulus embedded in the writing surface.

31. The writing set of claim 28, wherein the stimulus is an electrical stimulus embedded in the writing surface.
